(19) United States
(12) Patent Application Publication
(10) Pub. No.: US 2026/0132070 A1
(43) Pub. Date: May 14, 2026

(54) METHODS AND APPARATUS FOR MANUFACTURING A GLASS RIBBON

(71) Applicant: CORNING INCORPORATED, CORNING, NY (US)

(72) Inventors: Benjamin Logan Carl, Corning, NY (US); David Posada-Pineda, Elmira, NY (US); Paul Scherer, Lexington, KY (US)

(21) Appl. No.: 19/120,099

(22) PCT Filed: Oct. 30, 2023
(86) PCT No.: PCT/US2023/036267

§ 371 Date: Apr. 10, 2025

Related U.S. Application Data
(60) Provisional application No. 63/422,152, filed on Nov. 3, 2022.

(51) Int. Cl. C03B 35/16; C03B 17/06

(52) U.S. Cl. CPC C03B 35/16; C03B 17/068

(57) ABSTRACT

A glass manufacturing apparatus includes a delivery apparatus positioned at an upstream end of a travel path extending in a travel direction. The delivery apparatus directs a glass ribbon along the travel path. A first guide apparatus is positioned adjacent a first side of the travel path and guides the glass ribbon from a first orientation to a second orientation. A second guide apparatus is positioned adjacent the first side of the travel path downstream from the first guide apparatus. The second guide apparatus extends along an axis and contacts the glass ribbon across a width of the glass ribbon orthogonal to the travel direction. The second guide apparatus moves relative to the first guide apparatus along a plurality of guide paths that are orthogonal to the axis. Methods of manufacturing glass are provided.

### CROSS-REFERENCE TO RELATED APPLICATIONS

This application claims the benefit of priority under 35 U.S.C. § 119 of U.S. Provisional Application Ser. No. 63/422,152 filed on Nov. 3, 2022, the content of which is relied upon and incorporated herein by reference in its entirety.

### FIELD

The present disclosure relates generally to apparatus and methods for manufacturing a glass ribbon and, more particularly, to methods for manufacturing a glass ribbon with a guide apparatus.

### BACKGROUND

It is known to manufacture a glass ribbon with a glass manufacturing device. Conventional forming devices are known to operate to down draw a quantity of molten material from the glass ribbon forming device as the glass ribbon. However, the glass ribbon can exit warped across a width of the glass ribbon, particularly for glass ribbons of less than a certain thickness. Warp is undesirable and can reduce the quality of the glass ribbon.

### SUMMARY

The following presents a simplified summary of the disclosure to provide a basic understanding of some aspects described in the detailed description.

There are set forth methods of manufacturing glass with a guide apparatus. For example, a glass ribbon can be redirected by a turning apparatus to move from a vertical orientation to a horizontal orientation. Upon reaching the horizontal orientation, the guide apparatus can contact and apply a tension to the glass ribbon. By applying tension to the glass ribbon, warp within the glass ribbon can be reduced. Further, a position of the guide apparatus relative to the glass ribbon can be adjusted. That is, the guide apparatus is movable along a plurality of guide paths. In this way, the guide apparatus can be positionally adjusted to alter the magnitude of tension applied to the glass ribbon. Further, by adjusting the position of the guide apparatus, the guide apparatus can accommodate for variations in the glass ribbon, for example, a thickness of the glass ribbon, a position of the glass ribbon relative to the guide apparatus, etc.

In aspects, a glass manufacturing apparatus can comprise a delivery apparatus positioned at an upstream end of a travel path extending in a travel direction. The delivery apparatus can direct a glass ribbon along the travel path in the travel direction of the delivery apparatus. The glass manufacturing apparatus can comprise a first guide apparatus positioned adjacent a first side of the travel path and configured to guide the glass ribbon from a first orientation to a second orientation different than the first orientation. The glass manufacturing apparatus can comprise a second guide apparatus positioned adjacent the first side of the travel path downstream from the first guide apparatus. The second guide apparatus can extend along an axis and can contact the glass ribbon across a width of the glass ribbon orthogonal to the travel direction. The second guide apparatus can move relative to the first guide apparatus along a plurality of guide paths that are orthogonal to the axis.

In aspects, the glass manufacturing apparatus can comprise a support bracket attached to the first guide apparatus and the second guide apparatus. The support bracket and the second guide apparatus can move relative to the first guide apparatus.

In aspects, the support bracket can comprise an attachment arm attached to the first guide apparatus at a first location of the attachment arm and attached to the second guide apparatus at a second location of the attachment arm. The attachment arm can comprise an elongated opening extending along an opening axis parallel to a first guide path of the plurality of guide paths and configured to receive a fastener therethrough such that the attachment arm can translate along the opening axis.

In aspects, the support bracket can comprise an adjustment member comprising a channel within which an elongated guide arm can be received. The elongated guide arm can be attached to an end of the first guide apparatus. The adjustment member can move along the elongated guide arm along a second guide path of the plurality of guide paths.

In aspects, the first guide path and the second guide path can form an angle within a range from about 45 degrees to about 135 degrees.

In aspects, the support bracket can comprise a holding block comprising a block opening within which an end of the second guide apparatus is received. The block opening can be bounded on a first side by a wall of the holding block and unbounded on an opposing second side.

In aspects, the first guide apparatus can comprise a gas bearing spaced apart from the travel path and configured to direct a gas toward the travel path to guide the glass ribbon.

In aspects, the second guide apparatus can comprise a roller extending along the axis and configured to contact a first major surface of the glass ribbon.

In aspects, a glass manufacturing apparatus can comprise a delivery apparatus positioned at an upstream end of a travel path extending in a travel direction. The delivery apparatus can direct a glass ribbon along the travel path in the travel direction of the delivery apparatus. The glass manufacturing apparatus can comprise a first guide apparatus positioned adjacent a first side of the travel path and configured to guide the glass ribbon from a first orientation to a second orientation different than the first orientation. The glass manufacturing apparatus can comprise a second guide apparatus positioned adjacent the first side of the travel path downstream from the first guide apparatus. The second guide apparatus can contact the glass ribbon across a width of the glass ribbon orthogonal to the travel direction. The glass manufacturing apparatus can comprise a support bracket attached to the first guide apparatus and the second guide apparatus. The support bracket can move the second guide apparatus relative to the first guide apparatus along a first guide path, parallel to the first orientation of the glass ribbon, and a second guide path, forming an angle relative to the first guide path within a range from about 45 degrees to about 135 degrees.

In aspects, the support bracket can comprise an attachment arm attached to the first guide apparatus at a first location of the attachment arm and attached to the second guide apparatus at a second location of the attachment arm. The attachment arm can comprise an elongated opening extending along an opening axis parallel to the first guide path and configured to receive a fastener therethrough such that the attachment arm can be translatable along the opening axis.

In aspects, the support bracket can comprise an adjustment member comprising a channel within which an elongated guide arm is received. The elongated guide arm can be attached to an end of the first guide apparatus. The adjustment member can move along the elongated guide arm along the second guide path.

In aspects, the support bracket can comprise a holding block comprising a block opening within which an end of the second guide apparatus is received. The block opening can be bounded on a first side by a wall of the holding block and unbounded on an opposing second side.

In aspects, the support bracket can comprise a holding block comprising a block opening within which an end of the second guide apparatus is received. The block opening can be bounded on a first side by a wall of the holding block and unbounded on an opposing second side.

In aspects, the first guide apparatus can comprise a gas bearing spaced apart from the travel path and configured to direct a gas toward the travel path to guide the glass ribbon.

In aspects, the second guide apparatus can comprise a roller configured to contact a first major surface of the glass ribbon. The second guide apparatus may be configured to apply a tensioning force to the glass ribbon to reduce a warp of the glass ribbon.

In aspects, methods of manufacturing glass can comprise moving a glass ribbon along a travel path in a travel direction. Methods can comprise guiding the glass ribbon from a first orientation to a second orientation different than the first orientation by engaging the glass ribbon with a first guide apparatus positioned adjacent a first side of the travel path. Methods can comprise contacting the glass ribbon across a width of the glass ribbon orthogonal to the travel direction with a second guide apparatus positioned downstream from the first guide apparatus. Methods can comprise adjusting a position of the second guide apparatus relative to the glass ribbon by moving the second guide apparatus along one or more of a first guide path parallel to the first orientation of the glass ribbon, or a second guide path forming an angle relative to the first guide path within a range from about 45 degrees to about 135 degrees.

In aspects, guiding the glass ribbon with the first guide apparatus can comprise directing a gas from the first guide apparatus toward the glass ribbon.

In aspects, contacting the glass ribbon across the width of the glass ribbon can comprise contacting a first major surface of the glass ribbon.

In aspects, adjusting the position of the second guide apparatus can comprise changing a distance separating the first guide apparatus from the second guide apparatus. The second guide apparatus may apply a tensioning force to the glass ribbon, thereby reducing a warp of the glass ribbon.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates focus area 2 of FIG. 1 of the glass manufacturing apparatus in accordance with aspects of the disclosure;

FIG. 3 illustrates a perspective view of a turning apparatus of the glass manufacturing apparatus in accordance with aspects of the disclosure;

FIG. 4 illustrates a sectional view of the turning apparatus along lines 4-4 of FIG. 3 in accordance with aspects of the disclosure;

FIG. 5 illustrates a sectional view of the turning apparatus along lines 5-5 of FIG. 3 in accordance with aspects of the disclosure;

FIG. 6 illustrates a side view of the turning apparatus along lines 6-6 of FIG. 5 in accordance with aspects of the disclosure; and

FIG. 7 illustrates an end view along lines 7-7 of FIG. 2 of a guide apparatus of the turning apparatus in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

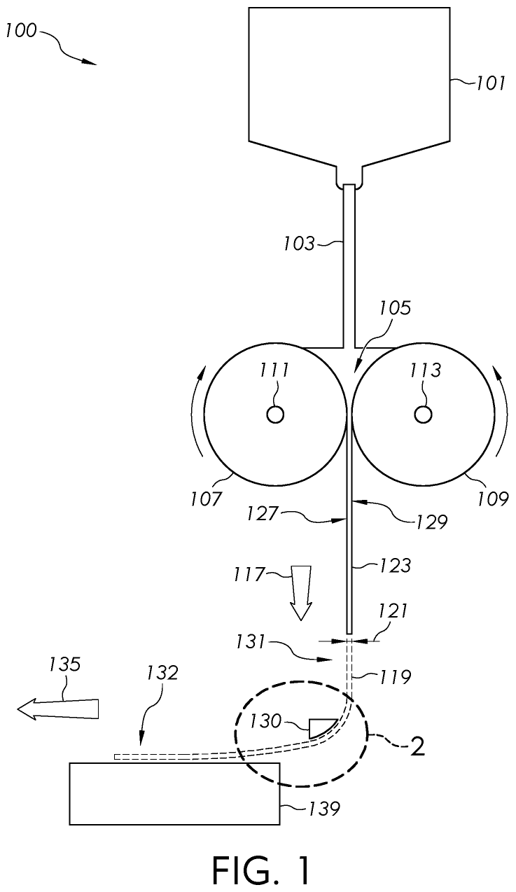

The present disclosure relates to a glass manufacturing apparatus and methods for manufacturing a glass ribbon. For purposes of this application, “ribbon” may be considered one or more of a glass ribbon in a viscous state, a glass ribbon in an elastic state (e.g., at room temperature) and/or a glass ribbon in a viscoelastic state between the viscous state and the elastic state. The glass ribbon may comprise a glass ribbon of an indeterminate length or one or more separated glass articles (e.g., separated ribbons, separated sheets, etc.) that comprise multiple, e.g., four, discrete edges. Methods and apparatus for manufacturing a glass ribbon will now be described by way of example aspects. As schematically illustrated in FIG. 1, in aspects, an exemplary glass manufacturing apparatus 100 can comprise a delivery apparatus 101 with a delivery conduit through which a stream of molten glass 103 can exit the delivery apparatus 101. For example, the delivery apparatus 101 can comprise an elongated passageway with an opening at the end of the delivery apparatus 101. In aspects, the delivery apparatus 101 can be oriented along a direction of gravity, such that the stream of molten glass 103 can flow downwardly along the direction of gravity from the delivery apparatus 101.

In aspects, the delivery apparatus 101 can be positioned at an upstream end of a travel path 119 extending in a travel direction 117. The delivery apparatus 101 can direct (e.g., convey, deliver, etc.) the stream of molten glass 103 along the travel path 119 in the travel direction 117. In aspects, the glass manufacturing apparatus 100 can comprise one or more pairs of opposing forming rolls, for example, a first forming roll 107 and a second forming roll 109. The second forming roll 109 may be spaced from the first forming roll 107 to define a gap 105. The gap 105 provides a glass ribbon 123 with a width and a thickness 121. In aspects, the first forming roll 107 and the second forming roll 109 can rotate counter to one another. For example, in the orientation shown in FIG. 1, the first forming roll 107 can rotate in a clockwise direction while the second forming roll 109 can rotate in a counter-clockwise direction. In aspects, the first forming roll 107 and the second forming roll 109 receive the stream of molten glass 103 along the travel path 119 within the gap 105. In aspects, the first forming roll 107 can extend along an axis 111 parallel to the travel path 119 and perpendicular to the travel direction 117. The second forming roll 109 can extend along an axis 113 parallel to the travel path 119 and perpendicular to the travel direction 117. The stream of molten glass 103 can accumulate between the first forming roll 107 and the second forming roll 109, whereupon the first forming roll 107 and the second forming roll 109 can flatten, thin, and smooth the stream of molten glass 103 into the glass ribbon 123. The glass ribbon 123 comprises a first major surface 127 and a second major surface 129.

A turning apparatus 130 may be located downstream from the forming rolls 107, 109 relative to the travel direction 117 to change the travel direction of the travel path 119. For example, the turning apparatus 130 can direct the glass ribbon 123 to turn about 90 degrees such that the glass ribbon 123 can move from a substantially vertical orientation (e.g., a first orientation 131) upstream from the turning apparatus 130 to a horizontal orientation (e.g., a second orientation 132) downstream from the turning apparatus 130. The turning apparatus 130 can extend along an axis parallel to the travel path 119, with the turning apparatus 130 configured to direct the glass ribbon 123 along the travel path 119 in a second travel direction 135 non-parallel to the travel direction 117. In aspects, a support surface 139 can be positioned downstream from the turning apparatus 130 (e.g., relative to a travel direction of the glass ribbon 123), with the support surface 139 configured to support the glass ribbon 123. In aspects, the support surface 139 can comprise a conveyor (e.g., a belt conveyor), one or more air bearings, one or more rollers, etc. Accordingly, methods of manufacturing glass can comprise moving the glass ribbon 123 along the travel path 119 in the travel direction 117, 135.

In aspects, the glass ribbon 123 may comprise, for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the glass ribbon 123 can be employed in a variety of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications. In aspects, the glass ribbon 123 can be used as a back-glass cover for a smartphone or other glass body for electronic component that has a non-uniform thickness.

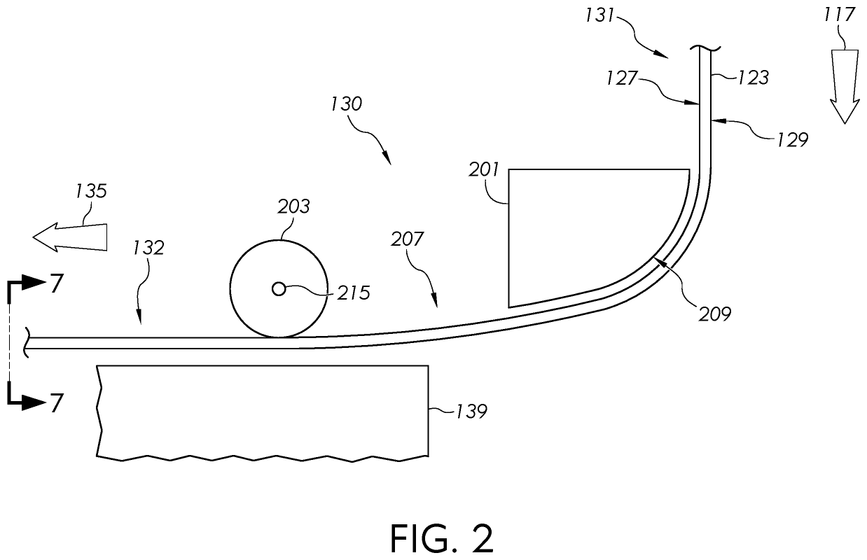

FIG. 2 illustrates focus area 2 of FIG. 1 of a portion of the turning apparatus 130 for directing the glass ribbon 123 from the substantially vertical orientation (e.g., the first orientation 131) to the horizontal orientation (e.g., the second orientation 132). In aspects, the turning apparatus 130 can comprise one or more guide apparatuses for guiding the glass ribbon 123, for example, a first guide apparatus 201 and a second guide apparatus 203. The first guide apparatus 201 may be positioned upstream from the second guide apparatus 203 relative to the travel direction 117, 135 of the glass ribbon 123. In aspects, the first guide apparatus 201 can be positioned adjacent to a first side 207 of the travel path such that the first guide apparatus 201 can guide the glass ribbon 123 form the first orientation 131 to the second orientation 132 that is different than the first orientation 131. In aspects, the first side 207 may be facing the first major surface 127. In aspects, the first guide apparatus 201 can comprise a gas bearing spaced apart from the travel path and configured to direct a gas toward the travel path to guide the glass ribbon 123. For example, the first guide apparatus 201 may be substantially hollow and may comprise a plurality of openings extending through a surface 209 of the first guide apparatus 201. The surface 209 may be adjacent and in proximity to the first major surface 127, such that the gas may pass through the plurality of openings toward the glass ribbon 123 and impinge upon the glass ribbon 123. In this way, the gas can facilitate directing of the glass ribbon 123 while also limiting the glass ribbon 123 from contacting the surface 209 of the first guide apparatus 201. In aspects, the surface 209 can comprise a rounded, semi-circular shape that may match a shape of the travel path along which the glass ribbon 123 travels when passing the first guide apparatus 201.

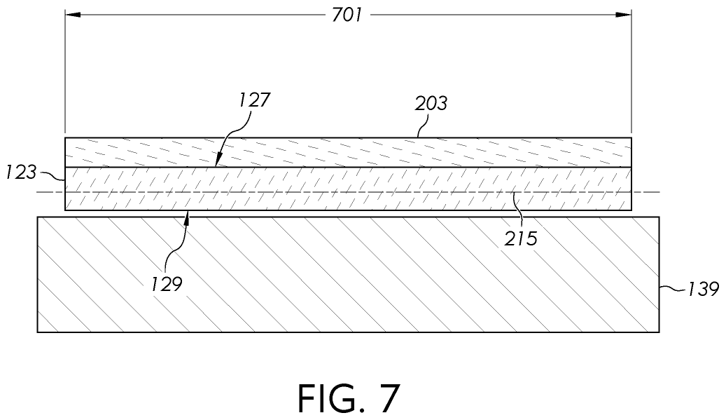

The turning apparatus 130 can comprise the second guide apparatus 203, with the second guide apparatus 203 positioned adjacent to the first side 207 of the travel path and downstream from the first guide apparatus 201 relative to the travel direction of the glass ribbon 123. The second guide apparatus 203 can extend along an axis 215 and may contact the glass ribbon 123 across a width (e.g., width 701 illustrated in FIG. 7) of the glass ribbon 123 orthogonal to the travel direction 135. In aspects, the second guide apparatus 203 can comprise a roller extending along the axis 215, with the roller configured to contact the first major surface 127 of the glass ribbon 123. Accordingly, methods can comprise guiding the glass ribbon 123 from the first orientation 131 to the second orientation 132 different than the first orientation 131 by engaging the glass ribbon 123 with the first guide apparatus 201 positioned adjacent the first side 207 of the travel path 119. In aspects, the second guide apparatus 203 is not limited to a roller and may comprise an air bearing that can emit gas toward the glass ribbon 123 to apply a force to the glass ribbon 123.

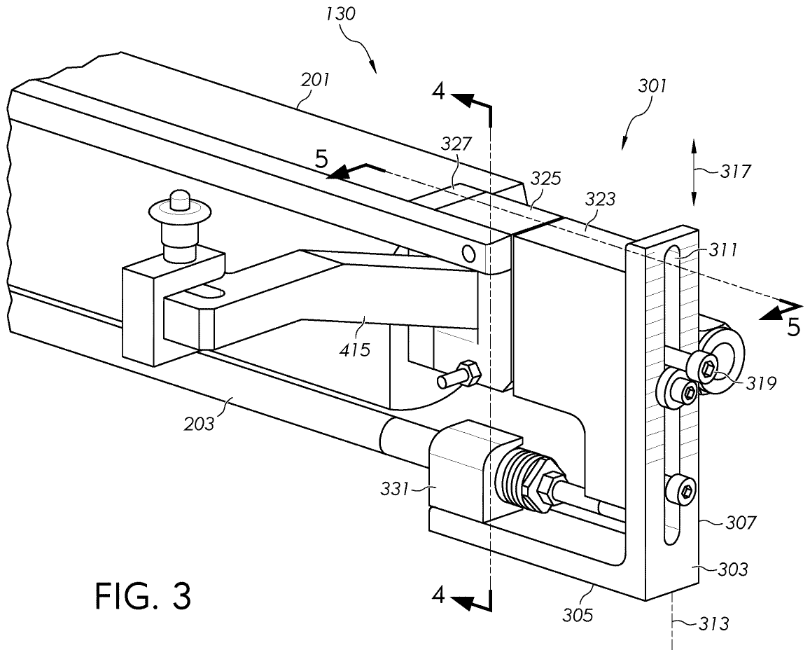

FIG. 3 illustrates a perspective view of the turning apparatus 130. In aspects, the turning apparatus 130 can comprise a support bracket 301 for attaching the first guide apparatus 201 to the second guide apparatus 203. For example, the support bracket 301 can be attached to the first guide apparatus 201 and the second guide apparatus 203 (e.g., at ends of the first guide apparatus 201 and the second guide apparatus 203), with the support bracket 301 and the second guide apparatus 203 configured to move relative to the first guide apparatus 201. In aspects, guiding the glass ribbon 123 with the first guide apparatus 201 can comprise directing a gas from the first guide apparatus 201 toward the glass ribbon 123.

The support bracket 301 can comprise an attachment arm 303 extending between the first guide apparatus 201 and the second guide apparatus 203. For example, in aspects, the attachment arm 303 may extend non-linearly, such as comprising an L-shape. The attachment arm 303 can comprise a first arm portion 305 and a second arm portion 307, with the first arm portion 305 angled relative to the second arm portion 307. In aspects, the first arm portion 305 may form an angle relative to the second arm portion 307 that is within a range from about 70 degrees to about 110 degrees, or 80 degrees to about 100 degrees, or about 90 degrees. In aspects, the first arm portion 305 can extend substantially horizontally along a first linear axis (e.g., parallel to the glass ribbon 123 in the second orientation 132), and the second arm portion 307 can extend substantially vertically along a second linear axis (e.g., parallel to the glass ribbon 123 in the first orientation 131). The attachment arm 303 can be attached to the first guide apparatus 201 at a first location of the attachment arm 303 (e.g., an end of the first arm portion 305 attached to the first guide apparatus 201) and attached to the second guide apparatus 203 at a second location of the attachment arm 303 (e.g., an end of the second arm portion 307 attached to the second guide apparatus 203).

The attachment arm 303, for example, the second arm portion 307, can comprise an elongated opening 311 extending along an opening axis 313 parallel to a first guide path 317 of a plurality of guide paths. In this way, the attachment arm 303 can receive a fastener 319 through the elongated opening 311 such that the attachment arm 303 may be translatable (e.g., movable, slidable, etc.) along the opening axis 313. The elongated opening 311 may extend through the second arm portion 307, for example, from one side to an opposing side of the second arm portion 307, with the elongated opening 311 bounded by a wall of the second arm portion 307. In aspects, the fastener 319 may extend through the elongated opening 311 such that the attachment arm 303 may move relative to the fastener 319.

The support bracket 301 can comprise an attachment block 323 in contact with and attached to the second arm portion 307. For example, the attachment block 323 may extend along the opening axis 313 and be positioned adjacent to the elongated opening 311. The support bracket 301 can comprise an adjustment member 325 in contact with and attached to the attachment block 323, with the attachment block 323 positioned between the adjustment member 325 and the second arm portion 307. One or more fasteners can extend through the elongated opening 311 to attach the second arm portion 307 to the attachment block 323 and/or the adjustment member 325. In aspects, the support bracket 301 can comprise an attachment plate 327 in contact with and attached to the adjustment member 325, such that the adjustment member 325 may be positioned between the attachment block 323 and the attachment plate 327.

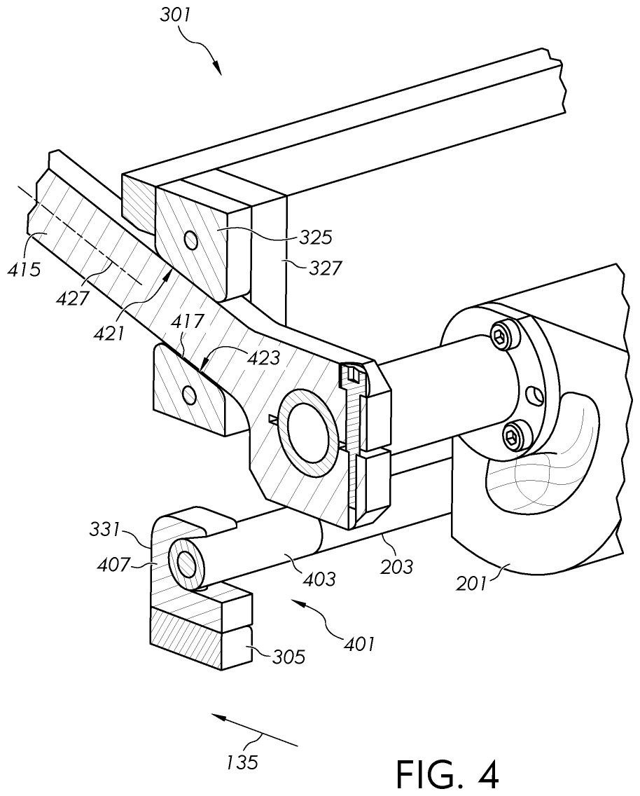

The support bracket 301 can comprise a holding block 331 attached to the first arm portion 305. The holding block 331 can be attached to an end of the first arm portion 305 in several ways, for example, via mechanical fasteners, adhesives, welding, etc. FIG. 4 illustrates a sectional view of portions of the support bracket 301 along lines 4-4 of FIG. 3. As illustrated in FIG. 4, the holding block 331 can comprise a block opening 401 within which an end 403 of the second guide apparatus 203 can be received. In aspects, the block opening 401 may be bounded on a first side by a wall 407 of the holding block 331, and unbounded on an opposing second side through which the end 403 can be received. In aspects, the block opening 401 may be on an opposite side of the holding block 331 than the second travel direction 135 of the glass ribbon 123. For example, as the glass ribbon 123 moves in contact with the second guide apparatus 203, the glass ribbon 123 may move in the second travel direction 135. In aspects, the second travel direction 135 may first pass through the block opening 401 followed by passing through the wall 407, such that the wall 407 is downstream from the block opening 401 relative to the second travel direction 135. In this way, as the glass ribbon 123 contacts the second guide apparatus 203 and applies a force to the second guide apparatus 203 in the second travel direction 135, the end 403 may remain within the block opening 401 in contact with and biased toward the wall 407, thus limiting the likelihood of the end 403 being removed from the block opening 401. Accordingly, an operator can remove the end 403 from the block opening 401 when desired (e.g., by moving the end 403 in a direction opposite the second travel direction 135). In aspects, one or more tensioning nuts, washers, etc. can be attached to an end of the second guide apparatus 203 (e.g., outside of the holding block 331) to assist in maintaining the second guide apparatus 203 within the holding block 331.

In aspects, a guide arm 415 can pass through an opening 417 of the adjustment member 325, with the guide arm 415 attached to the first guide apparatus 201. For example, an end of the guide arm 415 can be attached to an end of the first guide apparatus 201, such that the guide arm 415 may be fixed relative to the first guide apparatus 201. The adjustment member 325 can comprise a first attachment wall 421 and a second attachment wall 423, with the first attachment wall 421 spaced apart from the second attachment wall 423 to form the opening 417 therebetween. In aspects, the first attachment wall 421 and the second attachment wall 423 can be angled to match a shape and inclination of the guide arm 415. In aspects, the opening 417 can comprise a size that is larger than a size of the guide arm 415, such that the adjustment member 325 can move relative to the guide arm 415. For example, the guide arm 415 can extend along an axis 427. As such, the adjustment member 325 can move relative to the guide arm 415 along the axis 427. In aspects, some or all of the support bracket 301 can comprise stainless-steel. In aspects, when the second guide apparatus 203 comprises a roller, the second guide apparatus 203 may comprise one or more of a ceramic, silicon carbide, graphite, or fused silica.

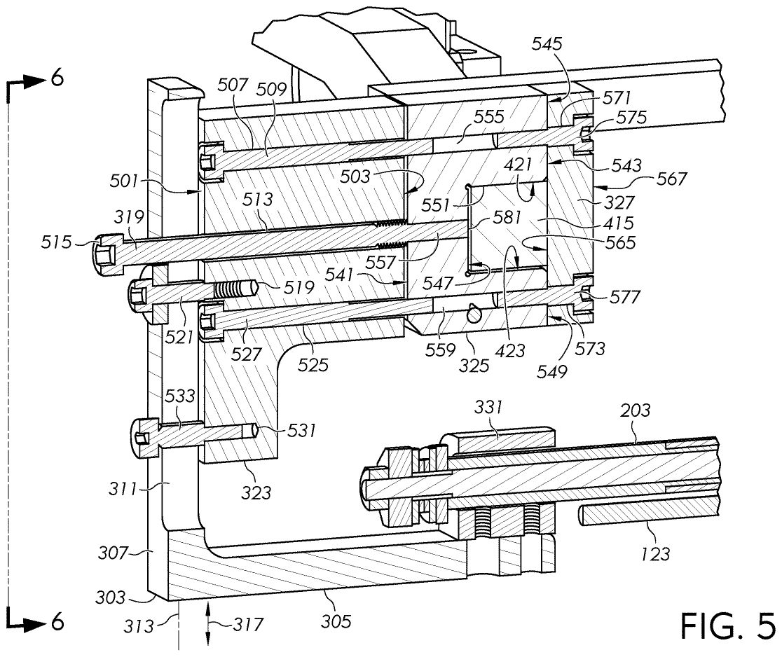

FIG. 5 illustrates a sectional view of the support bracket 301 along lines 5-5 of FIG. 3. In aspects, the attachment block 323 can extend between a first surface 501 and a second surface 503. The first surface 501 can be in contact with and attached to the second arm portion 307, and the second surface 503 can be parallel to, and spaced apart from, the first surface 501. The attachment block 323 can comprise one or more openings extending through the first surface 501 partially or completely through the attachment block 323 to the second surface 503. For example, the attachment block 323 can comprise a first opening 507 extending through the attachment block 323 from the first surface 501 to the second surface 503. The first opening 507 can be sized to receive a first fastener 509, with a head of the first fastener 509 positioned within a recess at the first surface 501. In aspects, the first fastener 509 can exit the first opening 507 at the second surface 503, such that the first fastener 509 can be attached (e.g., by threading) to the adjustment member 325.

The attachment block 323 can comprise a second opening 513 extending through the attachment block 323 from the first surface 501 to the second surface 503. The second opening 513 can be sized to receive the fastener 319 (e.g., also illustrated in FIG. 3). In aspects, the fastener 319 can extend through the elongated opening 311 and through the second opening 513 such that the fastener 319 can exit the second opening 513 at the second surface 503. In this way, the fastener 319 can be attached (e.g., by threading) to the adjustment member 325. In aspects, a head 515 of the fastener 319 can be larger in size than the elongated opening 311 such that the head 515 can remain on an opposite side of the second arm portion 307 from the attachment block 323.

The attachment block 323 can comprise a third opening 519 extending partially through the attachment block 323 from the first surface 501 toward the second surface 503. The third opening 519 can be sized to receive a third fastener 521. In aspects, the third fastener 521 may extend partially through the attachment block 323 such that the third fastener 521 may not contact the adjustment member 325. The third fastener 521 and the third opening 519 can be threaded, such that the third fastener 521 can be attached to the attachment block 323 by engaging the third opening 519. In aspects, a head of the third fastener 521 can be larger in size than the elongated opening 311 such that the third fastener 521 may remain within the elongated opening 311 and the head of the third fastener 521 can remain on an opposite side of the second arm portion 307 from the attachment block 323.

The attachment block 323 can comprise a fourth opening 525 extending through the attachment block 323 from the first surface 501 to the second surface 503. The fourth opening 525 can be sized to receive a fourth fastener 527, with a head of the fourth fastener 527 positioned within a recess at the first surface 501. In aspects, the fourth fastener 527 can exit the fourth opening 525 at the second surface 503, such that the fourth fastener 527 can be attached (e.g., by threading) to the adjustment member 325. In aspects, the first opening 507 and the fourth opening 525 may be substantially identical in size and shape and spaced apart with the second opening 513 and the third opening 519 positioned between the first opening 507 and the fourth opening 525. In aspects, the first fastener 509 and the fourth fastener 527 can be substantially identical in size and shape, with the first fastener 509 and the fourth fastener 527 attached to the adjustment member 325.

The attachment block 323 can comprise a fifth opening 531 extending partially through the attachment block 323 from the first surface 501 toward the second surface 503. The fifth opening 531 can be sized to receive a fifth fastener 533. In aspects, the fifth fastener 533 may extend partially through the attachment block 323 such that the fifth fastener 533 may not contact the adjustment member 325. The fifth fastener 533 and the fifth opening 531 can be threaded, such that the fifth fastener 533 can be attached to the attachment block 323 by engaging the fifth opening 531. In aspects, a head of the fifth fastener 533 can be larger in size than the elongated opening 311 such that the fifth fastener 533 may remain within the elongated opening 311 and the head of the fifth fastener 533 can remain on an opposite side of the second arm portion 307 from the attachment block 323. The fourth opening 525 may be positioned between the third opening 519 and the fifth opening 531.

Together, the third fastener 521 and the fifth fastener 533 can limit the attachment block 323 from rotating relative to the attachment arm 303 while allowing for the attachment arm 303 to move (e.g., slide, translate, etc.) relative to the attachment arm 303 along the first guide path 317 (e.g., parallel to the opening axis 313). For example, the third fastener 521 and the fifth fastener 533 can be tightened (e.g., rotated) and inserted further into the third opening 519 and the fifth opening 531 of the attachment block 323, which can bias the second arm portion 307 into contact with the attachment block 323. With the third fastener 521 and the fifth fastener 533 tightened, the second arm portion 307 may be fixed and not movable along the first guide path 317 relative to the attachment block 323. In aspects, the third fastener 521 and the fifth fastener 533 can be loosened to allow the attachment arm 303 to move relative to the attachment arm 303 along the first guide path 317. For example, the third fastener 521 and the fifth fastener 533 can be loosened (e.g., rotated) and retracted from the third opening 519 and the fifth opening 531, which can reduce the force applied by the third fastener 521 and the fifth fastener 533 to the second arm portion 307 toward the attachment block 323. With the third fastener 521 and the fifth fastener 533 loosened, the second arm portion 307 can move relative to the attachment arm 303 along the first guide path 317, for example, with the second arm portion 307 moving upwardly or downwardly as the third fastener 521 and the fifth fastener 533 remain within the elongated opening 311. Upon the second arm portion 307 reaching a desired position along the first guide path 317, the third fastener 521 and the fifth fastener 533 can be tightened, thus biasing the second arm portion 307 toward the attachment block 323 to fix the attachment arm 303 in a static position relative to the attachment block 323.

In aspects, the adjustment member 325 can extend between a first surface 541 and a second surface 543. The first surface 541 can be in contact with and attached to the second surface 503 of the attachment block 323. The second surface 543 can be parallel to, and spaced apart from, the first surface 541. In aspects, the second surface 543 may be non-planar, for example, and may comprise a first surface portion 545, a second surface portion 547, and a third surface portion 549. The first surface portion 545 and the third surface portion 549 may be parallel to and co-planar with the first surface portion 545. The second surface portion 547 may be parallel to and non-planar with the first surface portion 545 and the third surface portion 549. The second surface portion 547 is positioned between, and recessed from, the first surface portion 545 and the third surface portion 549, such that a distance separating the first surface 541 and the second surface portion 547 is less than a distance separating the first surface 541 and the first surface portion 545 or the third surface portion 549. In aspects, the adjustment member 325 can comprise a channel 551 within which the guide arm 415 can be received. For example, the channel 551 can be bounded by the second surface portion 547, by the first attachment wall 421 (e.g., extending between the first surface portion 545 and the second surface portion 547), and by the second attachment wall 423 (e.g., extending between the second surface portion 547 and the third surface portion 549). The first attachment wall 421 and the second attachment wall 423, also illustrated in FIG. 4, can be angled to match a shape and angle of the guide arm 415.

The adjustment member 325 can comprise one or more openings, for example, a first opening 555, a second opening 557, and a third opening 559. In aspects, the first opening 555 can extend through the adjustment member 325 from the first surface 541 to the second surface 543, for example, the first surface portion 545. For example, the adjustment member 325 can be aligned with the attachment block 323 such that the first opening 555 can extend coaxially with the first opening 507. In this way, the first fastener 509 can extend through the first opening 507 and into the first opening 555. In aspects, the first fastener 509 and an inner surface of the first opening 555 can be threaded, such that the first fastener 509 can be attached to the adjustment member 325 (e.g., by threading into the first opening 555). The first fastener 509 may extend partially, but not completely, through the first opening 555 such that the first fastener 509 can pass through the first surface 541 but may not exit the first opening 555 at the first surface portion 545 of the second surface 543. In aspects, the first openings 507, 555 can extend along an axis that does not intersect the channel 551.

In aspects, the second opening 557 can extend through the adjustment member 325 from the first surface 541 to the second surface 543, for example, the second surface portion 547. For example, the adjustment member 325 can be aligned with the attachment block 323 such that the second opening 557 can extend coaxially with the second opening 513. In this way, the fastener 319 can extend through the second opening 513 and into the second opening 557. In aspects, the fastener 319 and an inner surface of the second opening 557 can be threaded, such that the fastener 319 can be attached to the adjustment member 325 (e.g., by threading into the second opening 557). In aspects, the fastener 319 may extend completely through the second opening 557 such that the fastener 319 can pass through the first surface 541 and may exit the second opening 557 at the second surface portion 547. In aspects, the fastener 319 can contact the guide arm 415 and apply a force to the guide arm (e.g., in a direction away from the attachment block 323). The second openings 513, 557 can extend along an axis that intersects the channel 551.

In aspects, the third opening 559 can extend through the adjustment member 325 from the first surface 541 to the second surface 543, for example, the third surface portion 549. For example, the adjustment member 325 can be aligned with the attachment block 323 such that the third opening 559 can extend coaxially with the fourth opening 525. In this way, the fourth fastener 527 can extend through the fourth opening 525 and into the third opening 559. In aspects, the fourth fastener 527 and an inner surface of the third opening 559 can be threaded, such that the fourth fastener 527 can be attached to the adjustment member 325 (e.g., by threading into the third opening 559). The fourth fastener 527 may extend partially, but not completely, through the third opening 559 such that the fourth fastener 527 can pass through the first surface 541 but may not exit the third opening 559 at the third surface portion 549 of the second surface 543. In aspects, the fourth opening 525 and the third opening 559 can extend along an axis that does not intersect the channel 551.

In aspects, the attachment plate 327 can extend between a first surface 565 and a second surface 567. The first surface 565 can be in contact with and attached to the second surface 543 (e.g., the first surface portion 545 and the third surface portion 549) of the adjustment member 325. The first surface 565 can be parallel to, and spaced apart from, the second surface 567, with the first surface 565 and the second surface 567 substantially planar. In aspects, the first surface 565 can be parallel to, and spaced apart from, the second surface portion 547 of the second surface 543 of the adjustment member 325, such that the second surface portion 547, the first surface 565, and the walls 421, 423 can form the channel 551 within which the guide arm 415 is received.

The attachment plate 327 can comprise one or more openings, for example, a first opening 571 and a second opening 573. In aspects, the first opening 571 can extend through the attachment plate 327 from the first surface 565 to the second surface 567. The attachment plate 327 can be aligned with the adjustment member 325 such that the first opening 571 can extend coaxially with the first opening 555 of the adjustment member 325 and the first opening 507 of the attachment block 323. In this way, a first fastener 575 can extend through the first opening 571 and into the first opening 555 of the adjustment member 325. The first fastener 575 and an inner surface of the first opening 555 can be threaded, such that the first fastener 575 can attach the attachment plate 327 to the adjustment member 325 (e.g., by passing through the first opening 571 and threading into the first opening 555). The first fastener 575 may extend completely through the first opening 571 of the attachment plate 327 and partially through the first opening 555 of the adjustment member 325, for example, from the first surface portion 545 toward the first surface 541.

In aspects, the second opening 573 can extend through the attachment plate 327 from the first surface 565 to the second surface 567. The attachment plate 327 can be aligned with the adjustment member 325 such that the second opening 573 can extend coaxially with the third opening 559 of the adjustment member 325 and the fourth opening 525 of the attachment block 323. In this way, a second fastener 577 can extend through the second opening 573 and into the third opening 559 of the adjustment member 325. The second fastener 577 and an inner surface of the third opening 559 can be threaded, such that the second fastener 577 can attach the attachment plate 327 to the adjustment member 325 (e.g., by passing through the second opening 573 and threading into the third opening 559). The second fastener 577 may extend completely through the second opening 573 of the attachment plate 327 and partially through the third opening 559 of the adjustment member 325, for example, from the third surface portion 549 toward the first surface 541.

A width of the channel 551 (e.g., a distance between the second surface portion 547 of the adjustment member 325 and the first surface 565 of the attachment plate 327) may be less than or equal to a width of the guide arm 415. The attachment block 323, the adjustment member 325, and the attachment plate 327 may be fixed relative to one another, such that the adjustment member 325 and the attachment plate 327 can move relative to the guide arm 415. In aspects, the adjustment member 325 and the attachment plate 327 can be selectively fixed relative to the guide arm 415 such that, when fixed, the adjustment member 325 and the attachment plate 327 may not move relative to the guide arm 415. For example, to fix the adjustment member 325 and the attachment plate 327 relative to the guide arm 415 (e.g., such that there is no relative movement between the guide arm 415, the adjustment member 325, and the attachment plate 327), the fastener 319 can be rotated and threaded into the second opening 557 such that an end 581 of the fastener 319 can contact and abut the guide arm 415. The end 581 can apply a force to the guide arm 415 to bias the guide arm 415 toward the attachment plate 327, thus limiting the adjustment member 325 and the attachment plate 327 from moving relative to the guide arm 415. To allow for movement and/or adjustment of the adjustment member 325 and the attachment plate 327 relative to the guide arm 415, the fastener 319 can be unscrewed to move the end 581 away from the guide arm 415, such that the guide arm 415 may not be biased toward the attachment plate 327. The fasteners 319, 509, 521, 527, 533, 575, 577 illustrated in FIG. 5 are merely exemplary and the lengths of the fasteners 319, 509, 521, 527, 533, 575, 577 represent example aspects. In aspects, the fasteners 319, 509, 521, 527, 533, 575, 577 can be longer or shorter than as illustrated while functioning substantially identically as described herein.

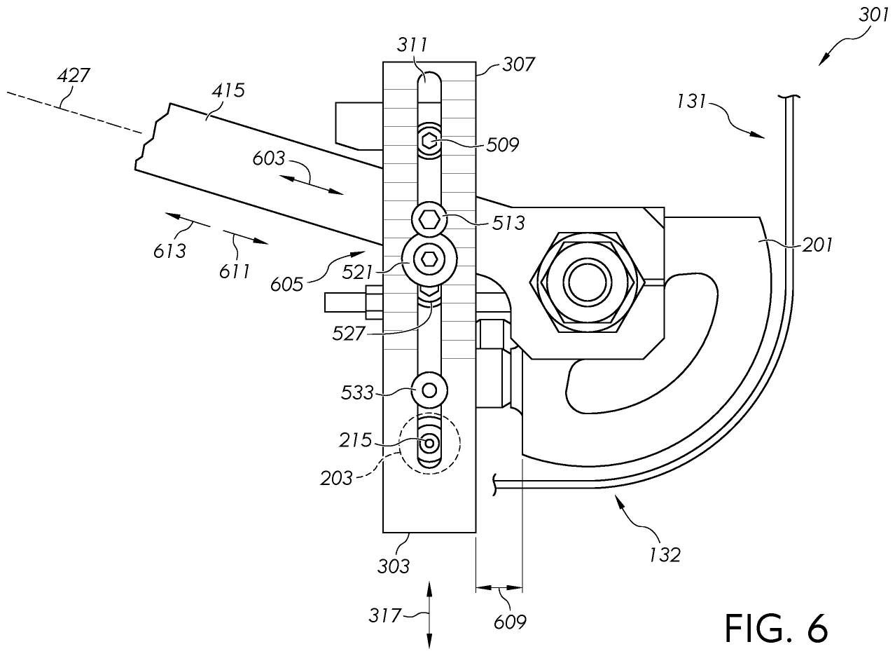

FIG. 6 illustrates an end of the support bracket 301 as viewed along lines 6-6 of FIG. 5. In aspects, the second guide apparatus 203 can move relative to the first guide apparatus 201 along a plurality of guide paths that are orthogonal to the axis 215. For example, the support bracket 301 can move the second guide apparatus 203 relative to the first guide apparatus 201 along the first guide path 317, parallel to the first orientation 131 of the glass ribbon 123, and a second guide path 603, forming an angle 605 relative to the first guide path 317 within a range from about 45 degrees to about 135 degrees. In aspects, the first guide path 317 is parallel to the opening axis 313 of the elongated opening 311 and perpendicular to the glass ribbon 123 when the glass ribbon 123 is in the second orientation 132. The attachment arm 303 can move along the first guide path 317 relative to the attachment block 323, the adjustment member 325, and the attachment plate 327. Accordingly, due to the first guide apparatus 201 being attached to the attachment arm 303, the first guide apparatus 201 and the attachment arm 303 can move together along the first guide path 317. By moving along the first guide path 317, the second guide apparatus 203 can move toward or away from the glass ribbon 123 (e.g., in a vertical direction relative to a direction of gravity).

In aspects, the second guide path 603 can be parallel to the axis 427 of the guide arm 415. Accordingly, methods can comprise adjusting a position of the second guide apparatus 203 relative to the glass ribbon 123 by moving the second guide apparatus 203 along one or more of the first guide path 317 parallel to the first orientation 131 of the glass ribbon 123, or the second guide path 603 forming the angle 605 relative to the first guide path 317 within a range from about 45 degrees to about 135 degrees. In aspects, adjusting the position of the second guide apparatus 203 can comprise changing a distance 609 separating the first guide apparatus 201 from the second guide apparatus 203. For example, by moving the second guide apparatus 203 along the second guide path 603, the second guide apparatus 203 can be moved toward the first guide apparatus 201 (e.g., illustrated in FIG. 6 in a first movement direction 611) or away from the first guide apparatus 201 (e.g., illustrated a second movement direction 613).

FIG. 7 illustrates a side view of the second guide apparatus 203 and the glass ribbon 123 along lines 7-7 of FIG. 2. In aspects, the second guide apparatus 203 can extend along the axis 215 and can contact the glass ribbon 123 across a width 701 of the glass ribbon 123 orthogonal to the travel direction (e.g., the second travel direction 135 illustrated in FIG. 1). In aspects, the axis 215 of the second guide apparatus 203 may be oriented substantially parallel to the first major surface 127 and the second major surface 129 of the glass ribbon 123, with the support surface 139 positioned on an opposite side of the glass ribbon 123 from the second guide apparatus 203. For example, the second guide apparatus 203 can contact the first major surface 127 while the support surface 139 may lie on a side facing the second major surface 129. The support surface 139 may support the glass ribbon 123 by being positioned below the glass ribbon 123 relative to the direction of gravity, with the support surface 139 comprising a conveyor, one or more air bearings, one or more rollers, etc. In aspects, the glass ribbon 123 can comprise a width 701 within a range from about 200 millimeters (“mm”) to about 350 mm and a thickness within a range from about 0.5 mm to about 8 mm. The glass ribbon 123 may comprise a uniform or a non-uniform thickness. In aspects, when moving from the first orientation 131 to the second orientation 132 and engaging the guide apparatuses 201, 203, the glass ribbon 123 can comprise a viscosity within a range from about 1×10⁵ poise to about 1×10⁹ poise.

In aspects, when the glass ribbon 123 comprises a thickness of less than a certain thickness, for example, about 0.8 mm, the glass ribbon 123 may experience warp across the width 701 of the glass ribbon 123. To reduce warp and planarize the glass ribbon 123, the second guide apparatus 203 contacts the first major surface 127 and applies a downward force to the glass ribbon 123 in a direction toward the support surface 139. The glass ribbon 123 moves along the travel direction (e.g., the second travel direction 135 illustrated in FIG. 1) while the second guide apparatus 203 contacts the first major surface 127. To accommodate for a characteristic of the glass ribbon 123, for example, a position of the glass ribbon 123 relative to the second guide apparatus 203 and/or the support surface 139, a thickness of the glass ribbon 123, etc., the second guide apparatus 203 can be moved along the first guide path 317 and/or the second guide path 603 (e.g., illustrated in FIG. 6). In this way, the second guide apparatus 203 can adjust a length of the travel path of the glass ribbon 123 from the first guide apparatus 201 to a location downstream from the second guide apparatus 203. For example, when the second guide apparatus 203 contacts the glass ribbon 123 and applies a downward force or tension, the second guide apparatus 203 can increase the length of the travel path of the glass ribbon 123, which has the effect of reducing warp within the glass ribbon 123.

By moving the second guide apparatus 203, the magnitude of force applied by the second guide apparatus 203 to the glass ribbon 123 can be adjusted, thus allowing for warp to be minimized while also reducing the likelihood of damage to the glass ribbon 123. As such, the portion of the glass ribbon 123 downstream from the second guide apparatus 203 relative to the travel direction may be planarized and may comprise reduced or zero warp across the width 701. In this way, in aspects, methods can comprise contacting the glass ribbon 123 across the width 701 of the glass ribbon 123 orthogonal to the travel direction (e.g., the second travel direction 135) with the second guide apparatus 203 positioned downstream from the first guide apparatus 201. Contacting the glass ribbon 123 across the width 701 of the glass ribbon 123 can comprise contacting the first major surface 127 of the glass ribbon 123. While the support bracket 301 is illustrated as being attached on one end of the first guide apparatus 201 and one end of the second guide apparatus 203, a substantially identical support bracket can be positioned at an opposing end of the first guide apparatus 201 and the second guide apparatus 203, with the support brackets functioning in a substantially identical manner. In this way, the guide apparatuses can simultaneously move both ends of the second guide apparatus 203 along the plurality of guide paths 317, 603. In aspects, downstream from the second guide apparatus 203, the glass ribbon 123 can comprise a warp that is less than about 100 micrometers (“microns”), wherein the warp is a maximum deviation from a flat or nominal plane.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a delivery apparatus positioned at an upstream end of a travel path extending in a travel direction, the delivery apparatus configured to direct a glass ribbon along the travel path in the travel direction of the delivery apparatus;
a first guide apparatus positioned adjacent a first side of the travel path and configured to guide the glass ribbon from a first orientation to a second orientation different than the first orientation; and
a second guide apparatus positioned adjacent the first side of the travel path downstream from the first guide apparatus, the second guide apparatus extending along an axis and configured to contact the glass ribbon across a width of the glass ribbon orthogonal to the travel direction, the second guide apparatus configured to move relative to the first guide apparatus along a plurality of guide paths that are orthogonal to the axis.

2. The glass manufacturing apparatus of claim 1, further comprising a support bracket attached to the first guide apparatus and the second guide apparatus, the support bracket and the second guide apparatus configured to move relative to the first guide apparatus.

3. The glass manufacturing apparatus of claim 2, wherein the support bracket comprises an attachment arm attached to the first guide apparatus at a first location of the attachment arm and attached to the second guide apparatus at a second location of the attachment arm, the attachment arm comprising an elongated opening extending along an opening axis parallel to a first guide path of the plurality of guide paths and configured to receive a fastener therethrough such that the attachment arm is translatable along the opening axis.

4. The glass manufacturing apparatus of claim 3, wherein the support bracket comprises an adjustment member comprising a channel within which an elongated guide arm is received, the elongated guide arm attached to an end of the first guide apparatus, the adjustment member configured to move along the elongated guide arm along a second guide path of the plurality of guide paths.

5. The glass manufacturing apparatus of claim 4, wherein the first guide path and the second guide path form an angle within a range from about 45 degrees to about 135 degrees.

6. The glass manufacturing apparatus of claim 2, wherein the support bracket comprises a holding block comprising a block opening within which an end of the second guide apparatus is received, the block opening bounded on a first side by a wall of the holding block and unbounded on an opposing second side.

7. The glass manufacturing apparatus of claim 1, wherein the first guide apparatus comprises a gas bearing spaced apart from the travel path and configured to direct a gas toward the travel path to guide the glass ribbon.

8. The glass manufacturing apparatus of claim 1, wherein the second guide apparatus comprises a roller extending along the axis and configured to contact a first major surface of the glass ribbon.

9. The glass manufacturing apparatus of claim 1, wherein the second guide apparatus is configured to apply a tensioning force to the glass ribbon.

10. A glass manufacturing apparatus comprising:
a delivery apparatus positioned at an upstream end of a travel path extending in a travel direction, the delivery apparatus configured to direct a glass ribbon along the travel path in the travel direction of the delivery apparatus;
a first guide apparatus positioned adjacent a first side of the travel path and configured to guide the glass ribbon from a first orientation to a second orientation different than the first orientation;
a second guide apparatus positioned adjacent the first side of the travel path downstream from the first guide apparatus, the second guide apparatus configured to contact the glass ribbon across a width of the glass ribbon orthogonal to the travel direction; and
a support bracket attached to the first guide apparatus and the second guide apparatus, the support bracket configured to move the second guide apparatus relative to the first guide apparatus along a first guide path, parallel to the first orientation of the glass ribbon, and a second guide path, forming an angle relative to the first guide path within a range from about 45 degrees to about 135 degrees.

11. The glass manufacturing apparatus of claim 10, wherein the support bracket comprises an attachment arm attached to the first guide apparatus at a first location of the attachment arm and attached to the second guide apparatus at a second location of the attachment arm, the attachment arm comprising an elongated opening extending along an opening axis parallel to the first guide path and configured to receive a fastener therethrough such that the attachment arm is translatable along the opening axis.

12. The glass manufacturing apparatus of claim 11, wherein the support bracket comprises an adjustment member comprising a channel within which an elongated guide arm is received, the elongated guide arm attached to an end of the first guide apparatus, the adjustment member configured to move along the elongated guide arm along the second guide path.

13. The glass manufacturing apparatus of claim 9, wherein the support bracket comprises a holding block comprising a block opening within which an end of the second guide apparatus is received, the block opening bounded on a first side by a wall of the holding block and unbounded on an opposing second side.

14. The glass manufacturing apparatus of claim 9, wherein the first guide apparatus comprises a gas bearing spaced apart from the travel path and configured to direct a gas toward the travel path to guide the glass ribbon.

15. The glass manufacturing apparatus of claim 9, wherein the second guide apparatus comprises a roller configured to contact a first major surface of the glass ribbon.

16. The glass manufacturing apparatus of claim 10, wherein the second guide apparatus is configured to apply a tensioning force to the glass ribbon

17. A method of manufacturing glass comprising:
moving a glass ribbon along a travel path in a travel direction;
guiding the glass ribbon from a first orientation to a second orientation different than the first orientation by engaging the glass ribbon with a first guide apparatus positioned adjacent a first side of the travel path;
contacting the glass ribbon across a width of the glass ribbon orthogonal to the travel direction with a second guide apparatus positioned downstream from the first guide apparatus; and
adjusting a position of the second guide apparatus relative to the glass ribbon by moving the second guide apparatus along one or more of a first guide path parallel to the first orientation of the glass ribbon, or a second guide path forming an angle relative to the first guide path within a range from about 45 degrees to about 135 degrees.

18. The method of claim 17, wherein the guiding the glass ribbon with the first guide apparatus comprises directing a gas from the first guide apparatus toward the glass ribbon.

19. (canceled)

20. The method of claim 17, wherein adjusting the position of the second guide apparatus comprises changing a distance separating the first guide apparatus from the second guide apparatus.

21. The method of claim 17, wherein the second guide apparatus applies a tensioning force to the glass ribbon to reduce a warp of the glass ribbon.
